(19) United States
(12) Patent Application Publication
(10) Pub. No.: US 2026/0049520 A1
(43) Pub. Date: Feb. 19, 2026

(54) FENESTRATION UNITS INCLUDING THERMAL BREAKS

(71) Applicant: Pella Corporation, Pella, IA (US)

(72) Inventors: Evan Vande Haar, Pella, IA (US); Jon Hoogland, Pella, IA (US)

(73) Assignee: Pella Corporation, Pella, IA (US)

(21) Appl. No.: 19/301,283

(22) Filed: Aug. 15, 2025

Related U.S. Application Data
(60) Provisional application No. 63/684,022, filed on Aug. 16, 2024.

(51) Int. Cl. E06B 3/46; E06B 3/263

(52) U.S. Cl. CPC E06B 3/4636; E06B 3/263

(57) ABSTRACT

A door/window frame structure for making door/window casing such as doors and/or windows intended to be anchored to a supporting wall, said structure comprising at least one metal end element (2) suited to define the external surface (3) of the door/window frame and a substantially straight insulating element (4) suited to promote thermal insulation between the environments respectively located inside and outside with respect to the door/window frame structure. At least one pair of straight metal profile (13) is provided, which have a first end (16) intended to be directly coupled with the insulating element (4); at least one of the profiles of said pair has a second end (19) suited to be directly anchored to the metal end element (2).

### CROSS-REFERENCE TO RELATED APPLICATION

The present application claims priority to and the benefit of U.S. Provisional Application No. 63/684,022, filed Aug. 16, 2024, which is hereby incorporated by reference in its entirety for all purposes.

### BACKGROUND

Fenestration units are installed in buildings for various reasons, including facilitating ingress and egress and providing ventilation. Additionally, fenestration units provide a precipitation and wind barrier between the interior of a building and the exterior environment. Depending on the season, the temperatures of the interior of the building and the exterior environment may vary greatly and, as a result, fenestration units may be exposed to heat differentials. However, it is advantageous for fenestration units to resist temperature changes from the exterior environment such that the interior temperature of a building remains relatively constant.

### SUMMARY

Fenestration units including one or more thermal breaks are disclosed. In some embodiments, the thermal breaks are constructed of a material having a relatively low thermal conductivity, such as a polymer or a polymer composite. According to some embodiments, one or more of the thermal breaks are coupled to one or more adjacent frame members (for example, constructed of a material having a relatively high strength and a relatively high thermal conductivity, such as a metal) via spline connectors, which facilitate ease of assembly (for example, compared to other units in which one or more metal frame components are folded over a thermal break to facilitate securement). According to some embodiments, fenestration units further include one or more compressible pads that accommodate different thermal expansion characteristics of thermal breaks constructed of different materials (for example, fiberglass compared to a thermoplastic).

According to one example (“Example 1”), a fenestration unit includes a frame having an interior frame member and an exterior frame member adjacent the interior frame member. At least one of the interior frame member and the exterior frame member include a foot-receiving channel. A thermal break couples the interior frame member to the exterior frame member, and the thermal break includes a foot positioned in the foot-receiving channel. A spline is received by the foot of the thermal break and secures the thermal break to the at least one of the interior frame member and the exterior frame member.

According to another example (“Example 2”), the fenestration unit of Example 1, wherein the foot-receiving channel is a first foot-receiving channel, the foot is a first foot, the other of the interior frame member and the exterior frame member includes a second foot-receiving channel, and the thermal break includes a second foot positioned in the second foot-receiving channel.

According to another example (“Example 3”), the fenestration unit of Example 1, wherein the spline non-detachably secures the thermal break to the at least one of the interior frame member and the exterior frame member.

According to another example (“Example 4”), the fenestration unit of Example 2, wherein the spline is a first spline, and further including a second spline received by the second foot of the thermal break and securing the thermal break to the other of the interior frame member and the exterior frame member.

According to another example (“Example 5”), the fenestration unit of Example 2, wherein the thermal break further includes a neck between the first foot and the second foot.

According to another example (“Example 6”), the fenestration unit of Example 5, wherein the neck of the thermal break includes and interior chamber.

According to another example (“Example 7”), the fenestration unit of Example 1, wherein the thermal break is a first thermal break, and the fenestration unit further includes: an intermediate frame member coupled to the first thermal break opposite the interior frame member; and a second thermal break coupled to the intermediate frame member opposite the first thermal break, and the second thermal break coupled to the exterior frame member opposite the intermediate frame member.

According to another example (“Example 8”), the fenestration unit of Example 1, further including a compressible pad coupled to the thermal break and configured to be compressed upon thermal expansion of the thermal break.

According to another example (“Example 9”), the fenestration unit of Example 1, further including a sliding panel coupled to the frame.

According to another example (“Example 10”), the fenestration unit of Example 9, further including a fixed panel coupled to the frame.

According to another example (“Example 11”), the fenestration unit of Example 1, wherein the spline acts as a seal between the thermal break and the at least one of the interior frame member and the exterior frame member.

According to another example (“Example 12”), the fenestration unit of Example 1, wherein the spline includes an adhesive.

According to one example (“Example 13”), a method of assembling a fenestration unit includes: providing an interior frame member, an exterior frame member, and a thermal break, at least one of the interior frame member and the exterior frame member including a foot-receiving channel, and the thermal break including a foot; positioning the foot in the foot-receiving channel; positioning a spline between the foot and the at least one of the interior frame member and the exterior frame member; and coupling the thermal break to the other of the interior frame member and the exterior frame member.

According to another example (“Example 14”), the method of Example 13, wherein positioning the foot in the foot-receiving channel includes pivoting the at least one of the interior frame member and the exterior frame member relative to the thermal break.

According to another example (“Example 15”), the method of Example 13, wherein the foot-receiving channel is a first foot-receiving channel, the foot is a first foot, the spline is a first spline, the other of the interior frame member and the exterior frame member includes a second foot-receiving channel, the thermal break includes a second foot, and coupling the thermal break to the other of the interior frame member and the exterior frame member includes: positioning the second foot in the second foot-receiving channel; and positioning a second spline between the second foot and the other of the interior frame member and the exterior frame member.

According to another example (“Example 16”), the method of Example 13, wherein the thermal break is a first thermal break, and further including: providing an intermediate frame member and a second thermal break; and coupling the second thermal break between the intermediate frame member and the exterior frame member.

According to another example (“Example 17”), the method of Example 13, further including coupling a compressible pad to the thermal break.

According to another example (“Example 18”), the method of Example 13, further including coupling an auxiliary component between the thermal break and the at least one of the interior frame member and the exterior frame member.

According to another example (“Example 19”), the method of Example 18, wherein the auxiliary component includes an internal corner bracket.

According to another example (“Example 20”), the method of Example 13, wherein positioning the spline between the foot and the at least one of the interior frame member and the exterior frame member non-detachably secures the thermal break to the at least one of the interior frame member and the exterior frame member.

According to one example (“Example 21”), an interior frame member, an exterior frame member adjacent the interior frame member, a polymeric thermal break coupling the interior frame member to the exterior frame member, and a compressible pad configured to be compressed upon thermal expansion of the polymeric thermal break.

According to another example (“Example 22”), the fenestration unit of Example 21, wherein the compressible pad is disposed between the thermal break and a corner bracket of the frame.

The foregoing Examples are just that and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 is a perspective view of a fenestration unit including a fixed panel and a sliding panel, according to some embodiments.

FIG. 2 is an exterior side view of the fenestration unit of FIG. 1, according to some embodiments.

FIG. 3 is an interior side view of the fenestration unit of FIG. 1, according to some embodiments.

FIG. 4 is a side section view of the fenestration unit taken along line 4-4 of FIG. 1, according to some embodiments.

FIG. 5 is a side section view of an interior frame member, an exterior frame member, and a thermal break of the fenestration unit taken along line 4-4 of FIG. 1, according to some embodiments.

FIG. 6 is a side section view of the thermal break of the fenestration unit taken along line 4-4 of FIG. 1, according to some embodiments.

FIG. 7 is a detail side section view of the interior frame member, the thermal break, and a spline of the fenestration unit within line 7-7 of FIG. 5, according to some embodiments.

FIG. 8 is a top section view of the fenestration unit taken along line 8-8 of FIG. 1, according to some embodiments.

FIG. 9 is a top section view of the fenestration unit taken along line 9-9 of FIG. 1, according to some embodiments.

FIG. 10 is a side section view of the fenestration unit taken along line 10-10 of FIG. 1, according to some embodiments.

FIG. 11 is a partial perspective view of an upper corner of the fenestration unit of FIG. 1, according to some embodiments.

FIG. 12 is a side section view of the upper corner of the fenestration unit taken along line 12-12 of FIG. 11, according to some embodiments.

FIG. 13 is a perspective section view of a header of a frame of another fenestration unit, according to some embodiments.

FIG. 14 is a side section view of the header of the frame of FIG. 13, according to some embodiments.

FIG. 15 is a perspective section view of a header of a frame of another fenestration unit, according to some embodiments.

FIG. 16 is a side section view of the header of the frame of FIG. 15, according to some embodiments.

FIG. 17 is a side section view of a header of a frame of another fenestration unit, according to some embodiments.

FIG. 18 is a side section view of the header of the frame of FIG. 17, a fixed panel, and auxiliary components, according to some embodiments.

FIG. 19 is a perspective section view of the header of the frame, the fixed panel, and the auxiliary components of FIG. 18, according to some embodiments.

FIG. 20 is a partial perspective view of a jamb of a frame of another fenestration unit and auxiliary components, according to some embodiments.

FIG. 21 is a side section view of a header of a frame of another fenestration unit, according to some embodiments.

FIG. 22 is a side section view of a header of a frame of yet another fenestration unit, according to some embodiments.

FIG. 23 is a detail side section view of the interior frame member and the thermal break of the fenestration unit of FIG. 1 with an alternative spline, according to some embodiments.

FIG. 24 is a detail side section view of the interior frame member and the thermal break of the fenestration unit of FIG. 1 with another alternative spline, according to some embodiments.

FIG. 25 is a side section view of the frame of FIG. 17 with an interior frame member being pivoted relative to a thermal break to position a foot of the thermal break in a foot-receiving channel of the interior frame member, according to some embodiments.

FIG. 26 is a side section view of the frame of FIG. 17 with the foot of the thermal break positioned in the foot-receiving channel of the interior frame member, according to some embodiments.

FIG. 27 is a side section view of the frame of FIG. 17 with a spline being positioned between the first foot of the thermal break and the interior frame member, according to some embodiments.

FIG. 28 is a side section view of the frame of FIG. 17 with the spline positioned between the first foot of the thermal break and the interior frame member, according to some embodiments.

FIG. 29 is a side section view of the frame of FIG. 17 with a jamb cover and a panel locking device coupled to the interior frame member, the thermal break, and the exterior frame member, according to some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

### Description of Various Embodiments

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale but may be exaggerated to illustrate various aspects of the present disclosure, and in that regard, the drawing figures should not be construed as limiting.

### Fenestration Units

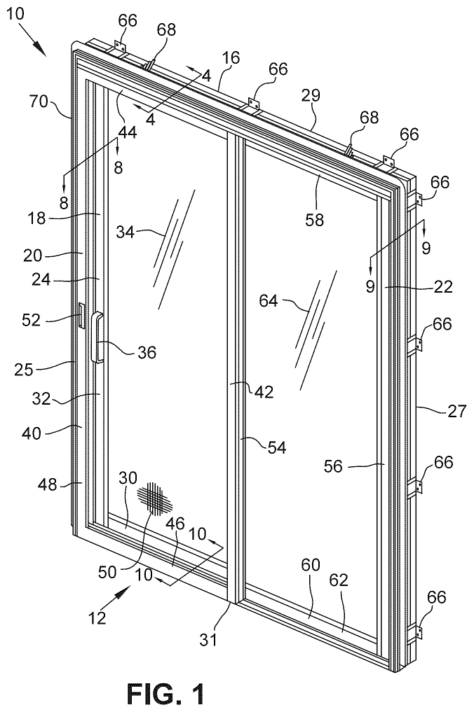

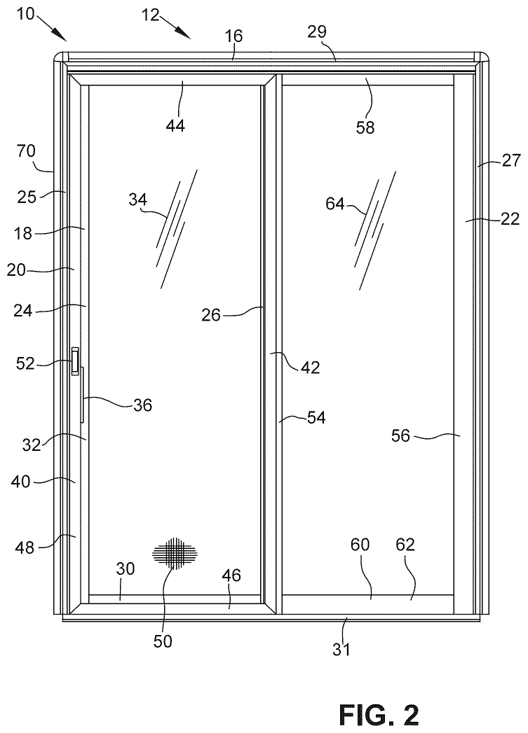

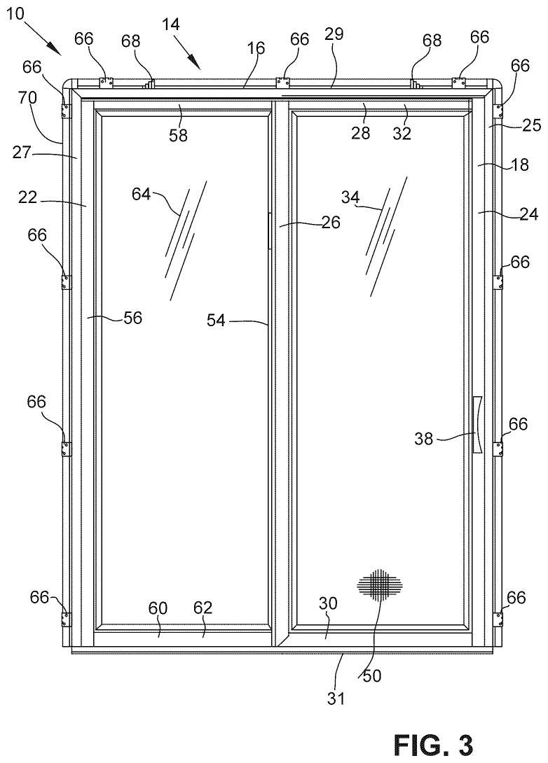

FIGS. 1-3 illustrate a fenestration unit 10, according to an embodiment of the present disclosure, for installation in a building structure (not shown). In the illustrations, the fenestration unit 10 is generally configured as a sliding door, although it should be understood that the fenestration unit 10 may be a sliding window, a single hung window, a double hung window, for example, or configured as another type of fenestration unit 10. FIGS. 1 and 2 illustrate the fenestration unit 10 from an exterior side 12 (for example, as the fenestration unit 10 would appear from an exterior of the building structure). FIG. 3 illustrates the fenestration unit 10 from an interior side 14 (for example, as the fenestration unit 10 would appear from an interior of the building structure). FIGS. 1-3 illustrate the fenestration unit 10 in a final, installed configuration, or installation configuration (for example, secured to the building structure). As described in further detail below, the fenestration unit 10 is also configurable in an initial, or pre-installation configuration (for example, as initially received by an installer).

Referring further to FIGS. 1-3, the fenestration unit 10 generally includes a frame 16, one or more sliding panels (illustratively, an interior or first sliding panel 18 and an exterior or second sliding panel 20-FIGS. 1 and 2), and one or more fixed panels (illustratively, a single fixed panel 22). As described in further detail below, the frame 16 includes components that facilitate thermal efficiency and expandability of the fenestration unit 10. Relatedly, the frame 16 facilitates easy attachment of adjacent components, such as jamb covers, locking brackets, sill bolsters, and accent/color pieces.

The frame 16 is operable to be positioned in an opening of a building structure and supports the sliding panels 18 and 20 and the fixed panel 22. The frame 16 generally includes a first jamb 25, a second jamb 27, a header 29, and a sill 31. The frame 16 and its components are described in further detail below.

The first sliding panel 18 is slidably positioned with the frame 16. The sliding panel 18 generally includes a first stile 24, a second stile 26 (FIG. 3), an upper rail 28 (FIG. 3), and a lower rail 30 defining a first sliding panel frame 32. The first sliding panel 18 includes a glazing unit 34 supported by the first sliding panel frame 32. The first stile 24 of the sliding panel 18 carries an exterior handle 36 (FIGS. 1 and 2) and an interior handle 38 (FIG. 3), which can be actuated to slide the sliding panel 18 between open and closed positions. The sliding panel 18 may include locking components (not shown) for engaging and/or locking the sliding panel 18 in the closed position. For example, the sliding panel 18 may be engaged with the frame 16 in the closed position when the locking components engage a corresponding locking structure on the frame 16, thereby limiting or inhibiting movement of the sliding panel 18.

Referring specifically to FIGS. 1 and 2, the second sliding panel 20 is slidably positioned with the frame 16. The second sliding panel 20 generally includes a first stile 40, a second stile 42, an upper rail 44, and a lower rail 46 defining a second sliding panel frame 48. The second sliding panel 20 includes a screen 50 supported by the second sliding panel frame 48. The first stile 40 of the sliding panel 20 carries a handle 52, which can be actuated to slide the sliding panel 20 between open and closed positions. The sliding panel 20 may include locking components (not shown) for engaging and/or locking the sliding panel 20 in the closed position. For example, the sliding panel 20 may be engaged with the frame 16 in the closed position when the locking components engage a corresponding structure on the frame 16, thereby limiting or inhibiting movement of the sliding panel 20.

Referring again to FIGS. 1-3, the fixed panel 22 is fixedly positioned with the frame 16. The fixed panel 22 generally includes a first stile 54, a second stile 56, an upper rail 58, and a lower rail 60 defining a fixed panel frame 62. The fixed panel 22 includes a glazing unit 64 supported by the fixed panel frame 62. The first stile 54 of the fixed panel 22 is positioned against the second jamb 27 of the frame 16.

Although the first sliding panel 18 and the fixed panel 22 may include glazing as described, in various embodiments the first sliding panel 18 and/or the fixed panel 22 may alternatively include opaque, solid, or filled panel designs that are not transparent (for example, wood, tile, fiberglass, vinyl, or other central paneling). Similarly, although the second sliding panel 20 may include a screen 50 as described, in various embodiments the second sliding panel 20 may alternatively include glazing or opaque, solid, or filled panel designs that are not transparent (for example, wood, tile, fiberglass, vinyl, or other central paneling).

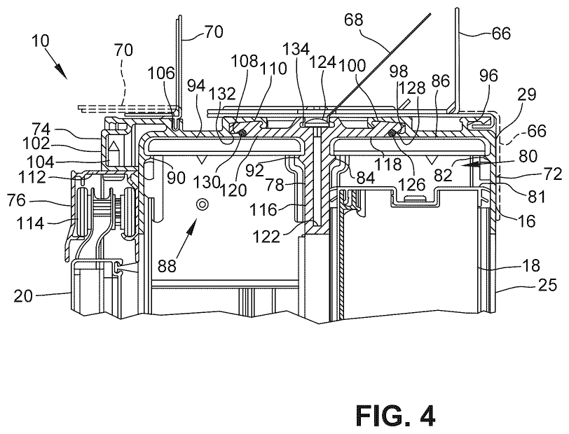

As shown in FIGS. 1-4, the fenestration unit 10 may include one or more installation features that facilitate installation of the fenestration unit 10 in the building structure. For example, the fenestration unit 10 may include one or more of the following installation features: a mounting bracket system (also described as an engagement system) including one or more mounting brackets 66 (FIGS. 1 and 3; illustratively, ten mounting brackets 66), a retention system including an installation stabilizer system having one or more retainers 68 (FIGS. 1 and 3; illustratively, two retainers 68), and a weather seal system including a fin assembly 70. These installation features may be the same or similar to the installation features described in U.S. Pat. No. 11,933,098, issued Mar. 19, 2024, U.S. Provisional Ser. No. 63/557,037, filed Feb. 23, 2024, U.S. Provisional Ser. No. 63/557,028, filed Feb. 23, 2024, U.S. Provisional Ser. No. 63/557,067, filed Feb. 23, 2024, U.S. patent application Ser. No. 18/646,289, filed Apr. 25, 2024, and entitled FENESTRATION UNIT INSTALLATION CLIPS AND ASSOCIATED METHODS, the U.S. application filed Aug. 16, 2024, identified by docket no. 426998.001107, and entitled FENESTRATION UNIT INSTALLATION CLIPS AND ASSOCIATED METHODS, the disclosures of which are hereby incorporated by reference for all purposes. The mounting brackets 66 and the fin assembly 70 are illustrated in deployed configurations, which configure the fenestration unit 10 for securement and sealing to the building structure in the final, installed configuration (for example, by driving fasteners (not shown) through the mounting brackets 66 and covering the fin assembly 70 with flashing tape (not shown)). As shown specifically with phantom lines in FIG. 4, the mounting brackets 66 and the fin assembly 70 are also configurable in relatively compact stowed configurations, which thereby configures the fenestration unit 10 in the initial, or pre-installation configuration (for example, as initially received by an installer).

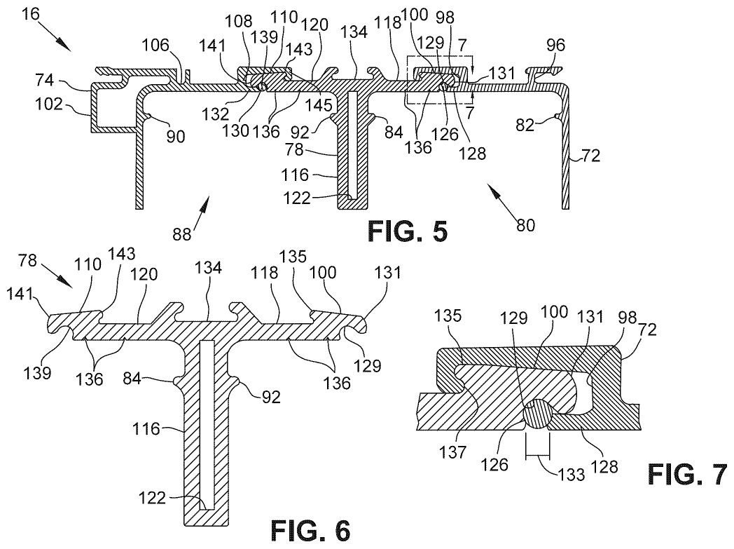

Referring to FIGS. 4-7, side section views of the fenestration unit 10 are illustrated. More specifically, FIG. 4 illustrates a section view of the header 29 of the frame 16, the first sliding panel 18, and the second sliding panel 20, FIGS. 5 and 7 illustrate a section view of an interior frame member 72, a first exterior frame member 74, a second exterior frame member 76 (FIG. 4), and an intermediate thermal break 78 of the frame 16, and FIG. 6 illustrates a section view of the thermal break 78. The interior frame member 72, the first exterior frame member 74, and the second exterior frame member 76 may be constructed of a first, relatively strong material, more specifically a metal, for example an aluminum alloy, and the thermal break 78 may be constructed of a second material having a lower thermal conductivity than the first material, more specifically a polymeric material, even more specifically a polymer or a polymer composite. The second material may have a thermal conductivity that is less than 10%, 5%, 1%, or 0.5%, for example, of the thermal conductivity of the first material. For example, the second material may be a thermoplastic (such as PVC), an extruded thermoplastic, a thermoset polymer, a composite (such as fiberglass, pultruded fiberglass, glass-filled polyamides), or the like. Accordingly, the thermal break 78 inhibits heat transfer between the frame members 72 and 74 and facilitates thermal efficiency of the fenestration unit 10.

The interior frame member 72 and the thermal break 78 bound and together define a first channel 80 (FIGS. 4 and 5) in which the first sliding panel 18 is partially disposed and movable. An upper seal 81 (FIG. 4) of the first sliding panel 18 is disposed in the first channel 80 and engages the interior frame member 72 and the thermal break 78. The interior frame member 72 and the thermal break 78 include mounting features 82 and 84, more specifically mounting protrusions 82 and 84, disposed in the first channel 80. The mounting features 82 and 84 facilitate coupling the interior frame member 72 and the thermal break 78 to auxiliary components disposed in the first channel 80, such as internal corner brackets 86 (FIG. 4; one internal corner bracket 86 being illustrated) coupling the header 29 to the first jamb 25 and the second jamb 27 (shown elsewhere). The first exterior frame member 74 and the thermal break 78 bound and together define a second channel 88 in which the fixed panel 22 (shown elsewhere) is partially disposed. The first exterior frame member 74 and the thermal break 78 include mounting features 90 and 92, more specifically mounting protrusions 90 and 92, disposed in the second channel 88. The mounting features 90 and 92 facilitate coupling the first exterior frame member 74 and the thermal break 78 to auxiliary components disposed in the second channel 88, such as internal corner brackets 94 (FIG. 4; one internal corner bracket 94 being illustrated) coupling the header 29 to the first jamb 25 and the second jamb 27 (shown elsewhere).

Referring specifically to FIGS. 4 and 5, the interior frame member 72 includes one or more channels or grooves for receiving, and thereby coupling to, adjacent components. As illustrated, the interior frame member 72 includes an interior accessory channel 96 for receiving one or more features of the mounting brackets 66 (FIG. 4) to facilitate coupling the mounting brackets 66 to the frame 16. The interior frame member 72 also includes a first foot-receiving channel 98 opposite the accessory channel 96. As described in further detail below, the first foot-receiving channel 98 receives a first foot 100 of the thermal break 78.

The first exterior frame member 74 includes one or more features for coupling to adjacent components. As illustrated, the first exterior frame member 74 includes an exterior flange 102 for coupling to the second exterior frame member 76, illustratively, via fasteners 104 (FIG. 4). The first exterior frame member 74 also includes an outer accessory channel 106 for receiving one or more features of the fin assembly 70 (FIG. 4) to facilitate coupling the fin assembly 70 to the frame 16. The first exterior frame member 74 further includes a second foot-receiving channel 108 opposite the exterior flange 102. As described in further detail below, the second foot-receiving channel 108 receives a second foot 110 of the thermal break 78.

With specific reference to FIG. 4, the second exterior frame member 76 includes an inner channel 112 that receives features of the second sliding panel 20, specifically a roller assembly 114 facilitating movement of the second sliding panel 20 relative to the frame 16. As described above, the second exterior frame member 76 is coupled to the first exterior frame member 74 via the fasteners 104. Alternatively, the second exterior frame member 76 may be coupled to the first exterior frame member 74 in other manners, or the second exterior frame member 76 may be monolithically formed with the first exterior frame member 74.

With reference again to FIGS. 4-7, the thermal break 78 includes a general “letter-T” shape. Stated another way, the thermal break 78 includes a central neck 116, a first leg 118 that extends from the neck 116 in a first direction, and a second leg 120 that extends from the neck 116 in a second, opposite direction. The neck 116 includes an interior chamber 122 to facilitate receiving a fastener 124 (FIG. 4) for coupling the retainer 68 to the thermal break 78. The first leg 118 includes the first foot 100 opposite the neck 116. The first foot 100 is received in the first foot-receiving channel 98 of the interior frame member 72, and a first spline 126 (FIGS. 4 and 5; for example, a generally round, a non-stretchable or compressible spline, such as a polyethylene, PVC, or synthetic rubber (such as, ethylene propylene diene monomer, (EPDM)) spline) is disposed against the first foot 100 and an inner wall 128 of the interior frame member 72 to couple the thermal break 78 to the interior frame member 72. More specifically, the inner wall 128 of the interior frame member 72 holds the first spline 126 in a concave recess 129 formed near a toe portion 131 of the first foot 100. Stated another way, the inner wall 128 and the first foot 100 hold the first spline 126 in the concave recess 129 by functionally enclosing the first spline 126. More specifically and as shown in FIG. 7, the inner wall 128 and the first foot 100 define a gap 133 at the opening of the recess 129 that is smaller than the width of the first spline 126, more specifically the diameter of the first spline 126. Contact between the first spline 126 with the inner wall 128 and the first foot 100 also holds an opposite ankle portion 135 of the first foot 100 in contact with the interior frame member 72, more specifically a hooked outer wall 137 of the interior frame member 72. This facilitates securing the first foot 100 in the first foot-receiving channel 98, which in turn secures the thermal break 78 and the interior frame member 72 to each other and thereby provides structural stability to the frame 16. In certain embodiments, the first spline 126 acts as a seal at the interface between the interior frame member 72 and the thermal break 78. These aspects are described in further detail below.

Similarly, the second leg 120 includes the second foot 110 opposite the neck 116. The second foot 110 is received in the second foot-receiving channel 108 of the first exterior frame member 74, and a second spline 130 (FIGS. 4 and 5; for example, a generally round, non-stretchable or compressible spline, such as a polyethylene, PVC, or synthetic rubber spline) is disposed against the second foot 110 and an inner wall 132 of the first exterior frame member 74 to couple the thermal break 78 to the first exterior frame member 74. More specifically, the inner wall 132 of the first exterior frame member 74 holds the second spline 130 in a concave recess 139 formed near a toe portion 141 of the second foot 110. Stated another way, the inner wall 132 and the second foot 110 hold the second spline 130 in the concave recess 139 by functionally enclosing the second spline 130. More specifically, the inner wall 132 and the second foot 110 define a gap at the opening of the recess 139 that is smaller than the width of the second spline 130, more specifically the diameter of the second spline 130. Contact between the second spline 130 with the inner wall 132 and the second foot 110 also holds an opposite ankle portion 143 of the second foot 110 in contact with the first exterior frame member 74, more specifically a hooked outer wall 145 of the first exterior frame member 74. This facilitates securing the second foot 110 in the second foot-receiving channel 108, which in turn secures the thermal break 78 and the first exterior frame member 74 to each other. In certain embodiments, the second spline 130 acts as a seal at the interface between the thermal break 78 and the first exterior frame member 74.

The thermal break 78 also includes an outer channel 134 for receiving one or more features of the mounting brackets 66 to facilitate coupling the mounting brackets 66 to the frame 16. The thermal break 78 further includes one or more notches 136 (FIGS. 5 and 6; illustratively, four notches 136) that facilitate receiving fasteners (not shown) for coupling the frame 16 to the building structure and/or mulling.

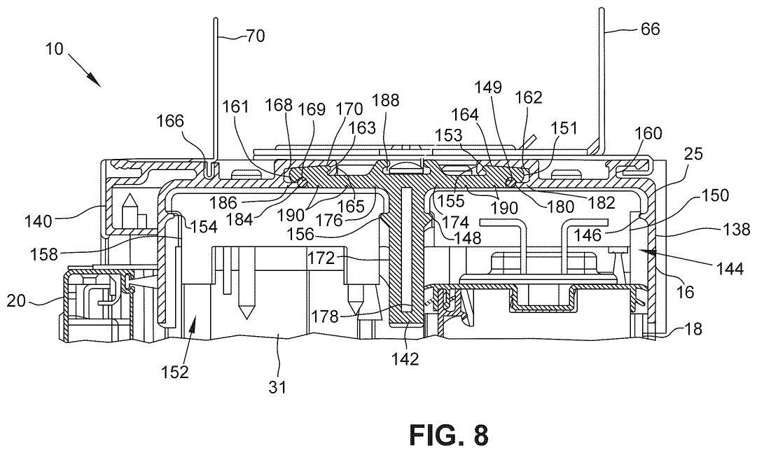

Referring to FIG. 8, a top section view of the fenestration unit 10 is illustrated. More specifically, a section view of the first jamb 25 of the frame 16, the first sliding panel 18, and the second sliding panel 20 is illustrated. The first jamb 25 includes an interior frame member 138, an exterior frame member 140, and an intermediate thermal break 142. The interior frame member 138 and the exterior frame member 140 may be constructed of the first, relatively strong material, as described above, more specifically a metal, for example aluminum, and the thermal break 142 may be constructed of the second material having a lower thermal conductivity than the first material, as described above, more specifically a polymeric material, even more specifically a polymer or a polymer composite. For example, the second material may be a thermoplastic (such as PVC), an extruded thermoplastic, a thermoset polymer, a composite (such as fiberglass, pultruded fiberglass, glass-filled polyamides), or the like. Accordingly, the thermal break 142 inhibits heat transfer between the frame members 138 and 140 and facilitates thermal efficiency of the fenestration unit 10.

The interior frame member 138 and the thermal break 142 bound and together define a first channel 144 in which the first sliding panel 18 is partially disposed and movable. The interior frame member 138 and the thermal break 142 include mounting features 146 and 148, more specifically mounting protrusions 146 and 148, disposed in the first channel 144. The mounting features 146 and 148 facilitate coupling the interior frame member 138 and the thermal break 142 to auxiliary components disposed in the first channel 144, such as internal corner brackets 150 (one internal corner bracket 150 being illustrated) coupling the first jamb 25 to the sill 31 and the header 29 (shown elsewhere). The exterior frame member 140 and the thermal break 142 bound and together define a second channel 152 in which the fixed panel 22 (shown elsewhere) is partially disposed. The exterior frame member 140 and the thermal break 142 include mounting features 154 and 156, more specifically mounting protrusions 154 and 156, disposed in the second channel 152. The mounting features 154 and 156 facilitate coupling the exterior frame member 140 and the thermal break 142 to auxiliary components disposed in the second channel 152, such as internal corner brackets 158 (one internal corner bracket 158 being illustrated) coupling the first jamb 25 to the sill 31 and the header 29 (shown elsewhere).

The interior frame member 138 may include the same or substantially similar features as the interior frame member 72 (shown elsewhere). More specifically, the interior frame member 138 includes one or more channels or grooves for receiving, and thereby coupling to, adjacent components. As illustrated, the interior frame member 138 includes an interior accessory channel 160 for receiving one or more features of the mounting brackets 66 to facilitate coupling the mounting brackets 66 to the frame 16. The interior frame member 138 also includes a first foot-receiving channel 162 opposite the accessory channel 160. As described in further detail below, the first foot-receiving channel 162 receives a first foot 164 of the thermal break 142.

The exterior frame member 140 may include the same or substantially similar features as the first exterior frame member 74 (shown elsewhere). More specifically, the exterior frame member 140 includes one or more features for coupling to adjacent components. As illustrated, the exterior frame member 140 includes an outer accessory channel 166 for receiving one or more features of the fin assembly 70 to facilitate coupling the fin assembly 70 to the frame 16. The exterior frame member 140 further includes a second foot-receiving channel 168. As described in further detail below, the second foot-receiving channel 168 receives a second foot 170 of the thermal break 142.

The thermal break 142 may include the same or substantially similar features as the thermal break 78 (shown elsewhere). That is, the thermal break 142 includes a general letter-T shape. Stated another way, the thermal break 142 generally includes a central neck 172, a first leg 174 that extends from the neck 172 in a first direction, and a second leg 176 that extends from the neck 172 in a second, opposite direction. The neck 172 includes an interior chamber 178. The first leg 174 includes the first foot 164 opposite the neck 172. The first foot 164 is received in the first foot-receiving channel 162 of the interior frame member 138, and a first spline 180 (for example, a generally round, non-stretchable or compressible spline, such as a polyethylene, PVC, or synthetic rubber spline) is disposed against the first foot 164 and an inner wall 182 of the interior frame member 138 to couple the thermal break 142 to the interior frame member 138. More specifically, the inner wall 182 of the interior frame member 138 holds the first spline 180 in a concave recess 149 formed near a toe portion 151 of the first foot 164. Stated another way, the inner wall 182 and the first foot 164 hold the first spline 180 in the concave recess 149 by functionally enclosing the first spline 180. More specifically, the inner wall 182 and the first foot 164 define a gap at the opening of the recess 149 that is smaller than the width of the first spline 180, more specifically the diameter of the first spline 180. Contact between the first spline 180 with the inner wall 182 and the first foot 164 also holds an opposite ankle portion 153 of the first foot 164 in contact with the interior frame member 138, more specifically a hooked outer wall 155 of the interior frame member 138. This facilitates securing the first foot 164 in the first foot-receiving channel 162, which in turn secures the thermal break 142 and the interior frame member 138 to each other. In certain embodiments, the first spline 180 acts as a seal at the interface between the interior frame member 138 and the thermal break 142.

Similarly, the second leg 176 includes the second foot 170 opposite the neck 172. The second foot 170 is received in the second foot-receiving channel 168 of the exterior frame member 140, and a second spline 184 (for example, a generally round, non-stretchable or compressible spline, such as a polyethylene, PVC, or synthetic rubber spline) is disposed against the second foot 170 and an inner wall 186 of the exterior frame member 140 to couple the thermal break 142 to the exterior frame member 140. More specifically, the inner wall 186 of the exterior frame member 140 holds the second spline 184 in a concave recess 169 formed near a toe portion 161 of the second foot 170. Stated another way, the inner wall 186 and the second foot 170 hold the second spline 184 in the concave recess 169 by functionally enclosing the second spline 184. More specifically, the inner wall 186 and the second foot 170 define a gap at the opening of the recess 169 that is smaller than the width of the second spline 184, more specifically the diameter of the second spline 184. Contact between the second spline 184 with the inner wall 186 and the second foot 170 also holds an opposite ankle portion 163 of the second foot 170 in contact with the exterior frame member 140, more specifically a hooked outer wall 165 of the exterior frame member 140. This facilitates securing the second foot 170 in the second foot-receiving channel 168, which in turn secures the thermal break 142 and the exterior frame member 140 to each other. In certain embodiments, the second spline 184 acts as a seal at the interface between the thermal break 142 and the exterior frame member 140.

The thermal break 142 also includes an outer channel 188 for receiving one or more features of the mounting brackets 66 to facilitate coupling the mounting brackets 66 to the frame 16. The thermal break 142 further includes one or more notches 190 (illustratively, four notches 190) that facilitate receiving fasteners (not shown) for coupling the frame 16 to the building structure and/or mulling.

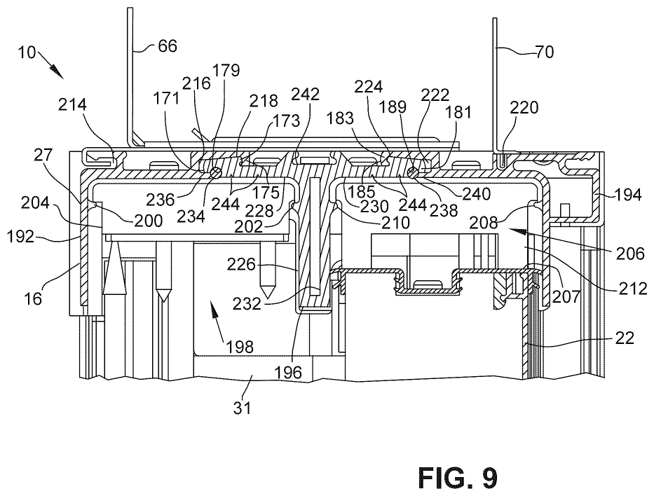

Referring to FIG. 9, a top section view of the fenestration unit 10 is illustrated. More specifically, a section view of the second jamb 27 of the frame 16 and the fixed panel 22 is illustrated. The second jamb 27 includes an interior frame member 192, an exterior frame member 194, and an intermediate thermal break 196. The interior frame member 192 and the exterior frame member 194 may be constructed of the first, relatively strong material, as described above, more specifically a metal, for example aluminum, and the thermal break 196 may be constructed of the second material having a lower thermal conductivity than the first material, as described above, more specifically a polymeric material, even more specifically a polymer or a polymer composite. For example, the second material may be a thermoplastic (such as PVC), an extruded thermoplastic, a thermoset polymer, a composite (such as fiberglass, pultruded fiberglass, glass-filled polyamides), or the like. Accordingly, the thermal break 196 inhibits heat transfer between the frame members 192 and 194 and facilitates thermal efficiency of the fenestration unit 10.

The interior frame member 192 and the thermal break 196 bound and together define a first channel 198 in which the first sliding panel 18 (shown elsewhere) is partially disposed and movable. The interior frame member 192 and the thermal break 196 include mounting features 200 and 202, more specifically mounting protrusions 200 and 202, disposed in the first channel 198. The mounting features 200 and 202 facilitate coupling the interior frame member 192 and the thermal break 196 to auxiliary components disposed in the first channel 198, such as internal corner brackets 204 (one internal corner bracket 204 being illustrated) coupling the second jamb 27 to the sill 31 and the header 29 (shown elsewhere). The exterior frame member 194 and the thermal break 196 bound and together define a second channel 206 in which the fixed panel 22 is partially disposed. An upper seal 207 of the fixed panel 22 is disposed in the second channel 206 and engages the exterior frame member 194 and the thermal break 196. The exterior frame member 194 and the thermal break 196 include mounting features 208 and 210, more specifically mounting protrusions 208 and 210, disposed in the second channel 206. The mounting features 208 and 210 facilitate coupling the exterior frame member 194 and the thermal break 196 to auxiliary components disposed in the second channel 206, such as internal corner brackets 212 (one internal corner bracket 212 being illustrated) coupling the second jamb 27 to the sill 31 and the header 29 (shown elsewhere).

The interior frame member 192 may include the same or substantially similar features as the interior frame member 72 or the interior frame member 138 (both shown elsewhere). More specifically, the interior frame member 192 includes one or more channels or grooves for receiving, and thereby coupling to, adjacent components. As illustrated, the interior frame member 192 includes an interior accessory channel 214 for receiving one or more features of the mounting brackets 66 to facilitate coupling the mounting brackets 66 to the frame 16. The interior frame member 192 also includes a first foot-receiving channel 216 opposite the accessory channel 214. As described in further detail below, the first foot-receiving channel 216 receives a first foot 218 of the thermal break 196.

The exterior frame member 194 may include the same or substantially similar features as the first exterior frame member 74 or the exterior frame member 140 (shown elsewhere). More specifically, the exterior frame member 194 includes one or more features for coupling to adjacent components. As illustrated, the exterior frame member 194 includes an outer accessory channel 220 for receiving one or more features of the fin assembly 70 to facilitate coupling the fin assembly 70 to the frame 16. The exterior frame member 194 further includes a second foot-receiving channel 222. As described in further detail below, the second foot-receiving channel 222 receives a second foot 224 of the thermal break 196.

The thermal break 196 may include the same or substantially similar features as the thermal break 78 or the thermal break 142 (shown elsewhere). That is, the thermal break 196 includes a general letter-T shape. Stated another way, the thermal break 196 generally includes a central neck 226, a first leg 228 that extends from the neck 226 in a first direction, and a second leg 230 that extends from the neck 226 in a second, opposite direction. The neck 226 includes an interior chamber 232. The first leg 228 includes the first foot 218 opposite the neck 226. The first foot 218 is received in the first foot-receiving channel 216 of the interior frame member 192, and a first spline 234 (for example, a generally round, non-stretchable or compressible spline, such as a polyethylene, PVC, or synthetic rubber spline) is disposed against the first foot 218 and an inner wall 236 of the interior frame member 192 to couple the thermal break 196 to the interior frame member 192. More specifically, the inner wall 236 of the interior frame member 192 holds the first spline 234 in a concave recess 179 formed near a toe portion 171 of the first foot 218. Stated another way, the inner wall 236 and the first foot 218 hold the first spline 234 in the concave recess 179 by functionally enclosing the first spline 234. More specifically, the inner wall 236 and the first foot 218 define a gap at the opening of the recess 179 that is smaller than the width of the first spline 234, more specifically the diameter of the first spline 234. Contact between the first spline 234 with the inner wall 236 and the first foot 218 also holds an opposite ankle portion 173 of the first foot 218 in contact with the interior frame member 192, more specifically a hooked outer wall 175 of the interior frame member 192. This facilitates securing the first foot 218 in the first foot-receiving channel 216, which in turn secures the thermal break 196 and the interior frame member 192 to each other. In certain embodiments, the first spline 234 acts as a seal at the interface between the interior frame member 192 and the thermal break 196.

Similarly, the second leg 230 includes the second foot 224 opposite the neck 226. The second foot 224 is received in the second foot-receiving channel 222 of the exterior frame member 194, and a second spline 238 (for example, a generally round, non-stretchable or compressible spline, such as a polyethylene, PVC, or synthetic rubber spline) is disposed against the second foot 224 and an inner wall 240 of the exterior frame member 194 to couple the thermal break 196 to the exterior frame member 194. More specifically, the inner wall 240 of the exterior frame member 194 holds the second spline 238 in a concave recess 189 formed near a toe portion 181 of the second foot 224. Stated another way, the inner wall 240 and the second foot 224 hold the second spline 238 in the concave recess 189 by functionally enclosing the second spline 238. More specifically, the inner wall 240 and the second foot 224 define a gap at the opening of the recess 189 that is smaller than the width of the second spline 238, more specifically the diameter of the second spline 238. Contact between the second spline 238 with the inner wall 240 and the second foot 224 also holds an opposite ankle portion 183 of the second foot 224 in contact with the exterior frame member 194, more specifically a hooked outer wall 185 of the exterior frame member 194. This facilitates securing the second foot 224 in the second foot-receiving channel 222, which in turn secures the thermal break 196 and the exterior frame member 194 to each other. In certain embodiments, the second spline 238 acts as a seal at the interface between the thermal break 196 and the exterior frame member 194.

The thermal break 196 also includes an outer channel 242 for receiving one or more features of the mounting brackets 66 to facilitate coupling the mounting brackets 66 to the frame 16. The thermal break 196 further includes one or more notches 244 (illustratively, four notches 244) that facilitate receiving fasteners (not shown) coupling the frame 16 to the building structure and/or mulling.

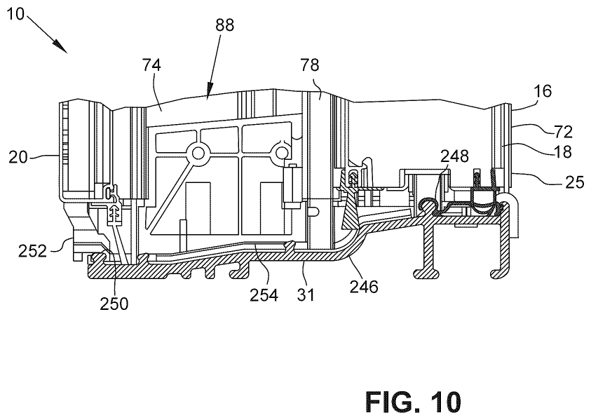

Referring to FIG. 10, a side section view of the fenestration unit 10 is illustrated. More specifically, a section view of the sill 31 of the frame 16, the first sliding panel 18, and the second sliding panel 20 is illustrated. The sill 31 includes a lower frame member 246 that movably supports the first sliding panel 18 and the second sliding panel 20. Illustratively, the lower frame member 246 includes a first rail 248 that supports a roller assembly (not shown) of the first sliding panel 18, and the lower frame member 246 includes a second rail 250 that supports an arm 252 of the second sliding panel 20. The lower frame member 246 couples to internal corner bracket 254 (two internal corner brackets 254 being illustrated) that are also coupled to the first jamb 25 and the second jamb 27 (shown elsewhere). The illustrated internal corner brackets 254 are received in the first channel 80 (shown elsewhere) defined by the interior frame member 72 and the thermal break 78 of the first jamb 25 and the second channel 88 defined by the first exterior frame member 74 of the first jamb 25.

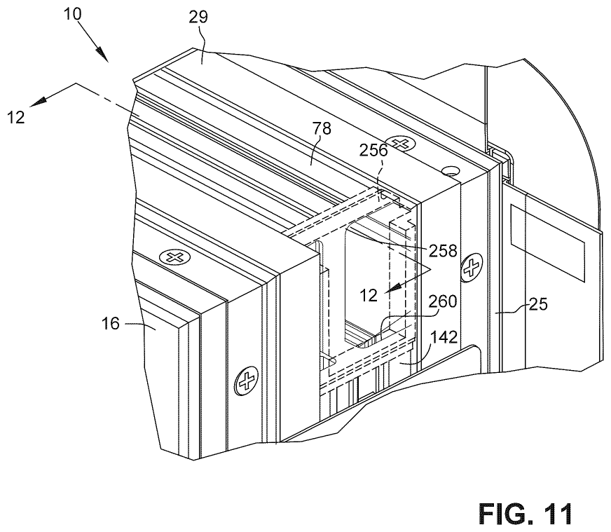

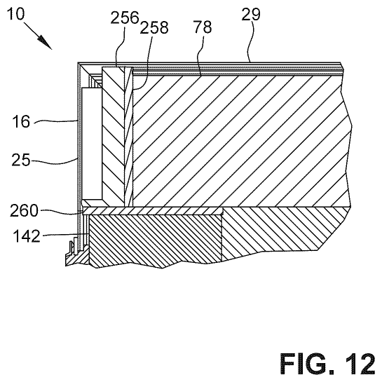

Referring now to FIGS. 11 and 12, an upper corner of the fenestration unit 10 is illustrated. In FIG, 11, an external corner bracket 256 of the frame 16 is shown with hidden lines for illustrative purposes. As illustrated, the frame 16 includes a first compressible pad 258 disposed between the thermal break 78 of the header 29 and the external corner bracket 256 and a second compressible pad 260 disposed between the thermal break 142 of the first jamb 25 and the external corner bracket 256. The compressible pads 258 and 260 are constructed of a resilient material, such as a polymer foam. The compressible pads 258 and 260 are compressed upon thermal expansion of the thermal breaks 78 and 142, respectively, and accommodate different thermal expansion characteristics of thermal breaks constructed of different materials (for example, fiberglass compared to a thermoplastic). Illustratively, the compressible pads 258 and 260 have general letter-T shapes, similar to the thermal breaks 78 and 142. Other corners of the frame 16 may additionally or alternatively include compressible pads having the same or similar features as the compressible pads 258 and 260.

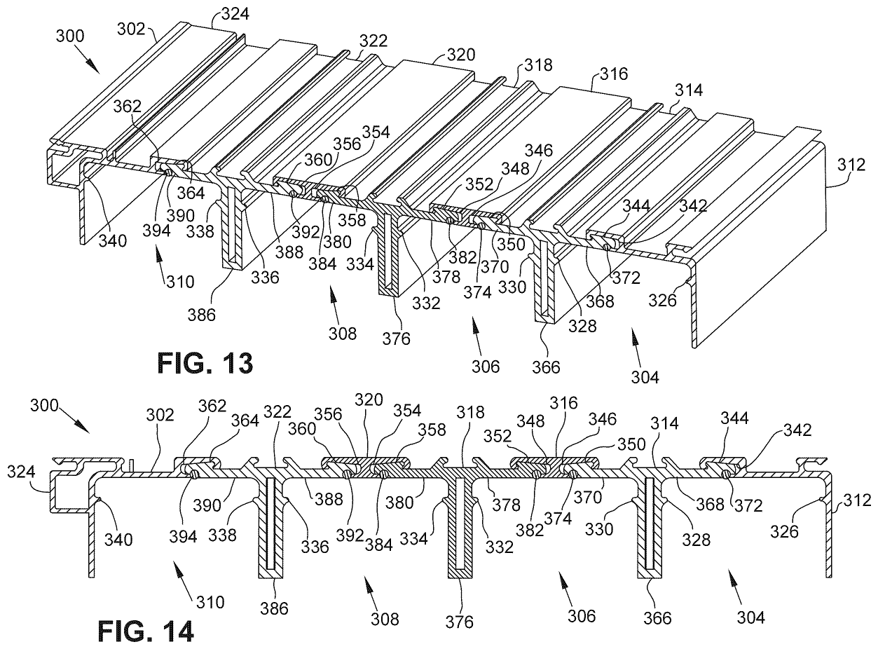

FIGS. 13 and 14 illustrate a portion of a frame 300 of a fenestration unit, according to an embodiment of the present disclosure, for installation in a building structure (not shown). More specifically, FIGS. 13 and 14 illustrate a portion of a header 302 of the frame 300. Although not specifically shown, a first jamb and a second jamb of the frame 300 may have substantially similar structures to the header 302.

The frame 300 generally includes the same or substantially similar components as the frame 16 of the fenestration unit 10 (shown elsewhere), although the frame 300 defines additional channels that receive sliding panels and/or fixed panels (not shown). Illustratively, the frame 300 includes four channels 304, 306, 308, and 310. In other embodiments, the frame 300 includes a different number of channels, such as three, five, six, seven, eight, nine, ten, or more channels.

The frame 300 includes a plurality of frame members and thermal breaks. More specifically, and progressing from the interior to the exterior of the frame 300, the frame 300 includes an interior frame member 312, a first thermal break 314, a first intermediate frame member 316, a second thermal break 318, a second intermediate frame member 320, a third thermal break 322, and an exterior frame member 324. The frame members 312, 316, 320, and 324 may be constructed of the first, relatively strong material, as described above, more specifically a metal, for example aluminum, and the thermal breaks 314, 318, and 322 may be constructed of the second material having a lower thermal conductivity than the first material, as described above, more specifically a polymeric material, even more specifically a polymer or a polymer composite. For example, the second material may be a thermoplastic (such as PVC), an extruded thermoplastic, a thermoset polymer, a composite (such as fiberglass, pultruded fiberglass, glass-filled polyamides), or the like. Accordingly, the thermal breaks 314, 318, and 322 inhibit heat transfer between the frame members 312, 316, 320, and 324 and facilitates thermal efficiency of the fenestration unit.

The interior frame member 312 and the first thermal break 314 bound and together define the first channel 304, in which a sliding panel or a fixed panel (not shown) is partially disposed. The interior frame member 312 and the first thermal break 314 include mounting features 326 and 328, more specifically mounting protrusions 326 and 328, disposed in the first channel 304. The mounting features 326 and 328 facilitate coupling the interior frame member 312 and the first thermal break 314 to auxiliary components disposed in the first channel 304, such as the internal corner brackets 86 and 94 (shown elsewhere).

The first thermal break 314, the first intermediate frame member 316, and the second thermal break 318 bound and together define the second channel 306, in which a sliding panel or a fixed panel (not shown) is partially disposed. The first thermal break 314 and the second thermal break 318 include mounting features 330 and 332, more specifically mounting protrusions 330 and 332, disposed in the second channel 306. The mounting features 330 and 332 facilitate coupling the first thermal break 314 and the second thermal break 318 to auxiliary components disposed in the second channel 306, such as the internal corner brackets 86 and 94 (shown elsewhere).

The second thermal break 318, the second intermediate frame member 320, and the third thermal break 322 bound and together define the third channel 308, in which a sliding panel or a fixed panel (not shown) is partially disposed. The second thermal break 318 and the third thermal break 322 include mounting features 334 and 336, more specifically mounting protrusions 334 and 336, disposed in the third channel 308. The mounting features 334 and 336 facilitate coupling the second thermal break 318 and the third thermal break 322 to auxiliary components disposed in the third channel 308, such as the internal corner brackets 86 and 94 (shown elsewhere).

The third thermal break 322 and the exterior frame member 324 bound and together define the fourth channel 310, in which a sliding panel or a fixed panel (not shown) is partially disposed. The third thermal break 322 and the exterior frame member 324 include mounting features 338 and 340, more specifically mounting protrusions 338 and 340, disposed in the fourth channel 310. The mounting features 338 and 340 facilitate coupling the third thermal break 322 and the exterior frame member 324 to auxiliary components disposed in the fourth channel 310, such as the internal corner brackets 86 and 94 (shown elsewhere).

The interior frame member 312 may be the same or substantially similar to the interior frame member 72 (shown elsewhere). More specifically, the interior frame member 312 includes a first foot-receiving channel 342 that receives a first foot 344 of the first thermal break 314. The first intermediate frame member 316 includes a second foot-receiving channel 346 and a third foot-receiving channel 348 that receive a second foot 350 of the first thermal break 314 and a third foot 352 of the second thermal break 318, respectively. The second intermediate frame member 320 includes a fourth foot-receiving channel 354 and a fifth foot-receiving channel 356 that receive a fourth foot 358 of the second thermal break 318 and a fifth foot 360 of the third thermal break 322, respectively. The exterior frame member 324 may be the same or substantially similar to the first exterior frame member 74 (shown elsewhere). The first exterior frame member 324 further includes a sixth foot-receiving channel 362 that receives a sixth foot 364 of the third thermal break 322.

The first thermal break 314, the second thermal break 318, and the third thermal break 322 may be the same or substantially similar to the thermal break 78 (shown elsewhere). More specifically, the first thermal break 314 includes a first central neck 366, a first leg 368 that extends from the first neck 366 in a first direction, and a second leg 370 that extends from the first neck 366 in a second, opposite direction. The first leg 368 includes the first foot 344 opposite the first neck 366, and the second leg 370 includes the second foot 350 opposite the first neck 366. The first foot 344 is received in the first foot-receiving channel 342 of the interior frame member 312, and a first spline 372 (for example, a non-stretchable or compressible spline, such as a polyethylene spline) is disposed against the first foot 344 to couple the first thermal break 314 to the interior frame member 312. The interface between the first spline 372, the first thermal break 314, and the interior frame member 312 may be the same or similar to the interface between the corresponding components of the fenestration unit 10. Similarly, the second leg 370 includes the second foot 350 opposite the first neck 366. The second foot 350 is received in the second foot-receiving channel 346 of the first intermediate frame member 316, and a second spline 374, which may be the same or substantially similar to the first spline 372, is disposed against the second foot 350 to couple the first thermal break 314 to the first intermediate frame member 316. The interface between the second spline 374, the first thermal break 314, and the first intermediate frame member 316 may be the same or similar to the interface between the corresponding components of the fenestration unit 10. The second thermal break 318 similarly includes a second central neck 376, a third leg 378 that extends from the second neck 376 in the first direction, and a fourth leg 380 that extends from the second neck 376 in the second direction. The third leg 378 includes the third foot 352 opposite the second neck 376, and the fourth leg 380 includes the fourth foot 358 opposite the second neck 376. The third foot 352 is received in the third foot-receiving channel 348 of the first intermediate frame member 316, and a third spline 382, which may be the same or substantially similar to the first spline 372, is disposed against the third foot 352 to couple the second thermal break 318 to the first intermediate frame member 316. The interface between the third spline 382, the second thermal break 318, and the first intermediate frame member 316 may be the same or similar to the interface between the corresponding components of the fenestration unit 10. Similarly, the fourth leg 380 includes the fourth foot 358 opposite the second neck 376. The fourth foot 358 is received in the fourth foot-receiving channel 354 of the second intermediate frame member 320, and a fourth spline 384, which may be the same or substantially similar to the first spline 372, is disposed against the fourth foot 358 to couple the second thermal break 318 to the second intermediate frame member 320. The interface between the fourth spline 384, the second thermal break 318, and the second intermediate frame member 320 may be the same or similar to the interface between the corresponding components of the fenestration unit 10. The third thermal break 322 similarly includes a third central neck 386, a fifth leg 388 that extends from the third neck 386 in the first direction, and a sixth leg 390 that extends from the third neck 386 in the second direction. The fifth leg 388 includes the fifth foot 360 opposite the third neck 386, and the sixth leg 390 includes the sixth foot 364 opposite the third neck 386. The fifth foot 360 is received in the fifth foot-receiving channel 356 of the second intermediate frame member 320, and a fifth spline 392, which may be the same or substantially similar to the first spline 372, is disposed against the fifth foot 360 to couple the third thermal break 322 to the second intermediate frame member 320. The interface between the fifth spline 392, the third thermal break 322, and the second intermediate frame member 320 may be the same or similar to the interface between the corresponding components of the fenestration unit 10. Similarly, the sixth leg 390 includes the sixth foot 364 opposite the third neck 386. The sixth foot 364 is received in the sixth foot-receiving channel 362 of the exterior frame member 324, and a sixth spline 394, which may be the same or substantially similar to the first spline 372, is disposed against the sixth foot 364 to couple the third thermal break 322 to the exterior frame member 324. The interface between the sixth spline 394, the third thermal break 322, and the exterior frame member 324 may be the same or similar to the interface between the corresponding components of the fenestration unit 10.

Other components of the fenestration unit of which the frame 300 forms a part may be the same or substantially similar to the components of the fenestration unit 10. For example, the fenestration unit of which the frame 300 forms a part may include sliding panels, fixed panels, and the like, that are the same or substantially similar to those of the fenestration unit 10.

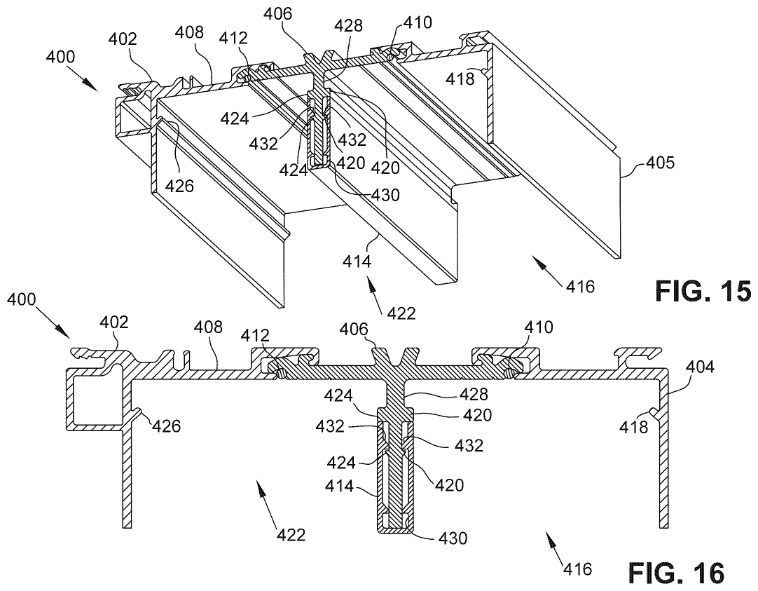

FIGS. 15 and 16 illustrate a portion of a frame 400 of a fenestration unit, according to an embodiment of the present disclosure, for installation in a building structure (not shown). More specifically, FIGS. 15 and 16 illustrate a portion of a header 402 of the frame 400. Although not specifically shown, a first jamb and a second jamb of the frame 400 may have substantially similar structures to the header 402.

The frame 400 generally includes the same or substantially similar components as the frame 16 of the fenestration unit 10 (shown elsewhere), particularly a plurality of frame members and one or more thermal breaks. More specifically, the frame 400 includes an interior frame member 404, a thermal break 406, an exterior frame member 408, a first spline 410 coupling the interior frame member 404 to the thermal break 406, and a second spline 412 coupling the thermal break 406 to the exterior frame member 408. The interface between the first spline 410, the thermal break 406, and the interior frame member 404 may be the same or similar to the interface between the corresponding components of the fenestration unit 10. Similarly, the interface between the second spline 412, the thermal break 406, and the exterior frame member 408 may be the same or similar to the interface between the corresponding components of the fenestration unit 10. The frame members 404 and 408 may be constructed of the first, relatively strong material, as described above, more specifically a metal, for example aluminum, and the thermal break 406 may be constructed of the second material having a lower thermal conductivity than the first material, as described above, more specifically a polymeric material, even more specifically a polymer or a polymer composite. For example, the second material may be a thermoplastic (such as PVC), an extruded thermoplastic, a thermoset polymer, a composite (such as fiberglass, pultruded fiberglass, glass-filled polyamides), or the like. Accordingly, the thermal break 406 inhibits heat transfer between the frame members 404 and 408 and facilitates thermal efficiency of the fenestration unit. The thermal break 406 also couples to a trim component 414, which may provide the frame 400 with an aesthetically appealing appearance (for example, by having a particular color). The trim component 414 may be constructed of a material with a relatively low thermal conductivity, such as the second material as described above.

The interior frame member 404, the thermal break 406, and the trim component 414 bound and together define a first channel 416, in which a sliding panel or a fixed panel (not shown) is partially disposed. The interior frame member 404 and the thermal break 406 include mounting features 418 and 420, more specifically mounting protrusions 418 and 420, disposed in the first channel 416. The mounting features 418 and 420 facilitate coupling the interior frame member 404 and the thermal break 406 to auxiliary components disposed in the first channel 416, such as the internal corner brackets 86 and 94 (shown elsewhere).

The thermal break 406, the exterior frame member 408, and the trim component 414 bound and together define a second channel 422, in which a sliding panel or a fixed panel (not shown) is partially disposed. The thermal break 406 and the exterior frame member 408 include mounting features 424 and 426, more specifically mounting protrusions 424 and 426, disposed in the second channel 422. The mounting features 424 and 426 facilitate coupling the thermal break 406 and the second thermal break 406 to auxiliary components disposed in the second channel 422, such as the internal corner brackets 86 and 94 (shown elsewhere).

The interior frame member 404 and the exterior frame member 408 may be the same or substantially similar to the interior frame member 72 and the exterior frame member 74, respectively (both shown elsewhere). The thermal break 406 may be the same or substantially similar to the thermal break 78 (shown elsewhere), except that the thermal break 406 lacks an outer channel for receiving features of mounting brackets, such as the outer channel 134 of the thermal break 78, and the neck 428 of the thermal break 406 includes additional mounting features 420 and 424 for coupling to auxiliary features and the trim component 414. Illustratively, the trim component 414 includes an interior channel 430 for receiving the neck 428 of the thermal break 406, and the interior channel 430 includes mounting features 432, more specifically mounting protrusions 432, for engaging some of the mounting features 420 and 424 of the thermal break 406. The mounting features 432 may provide the trim component 414 with a “snap” connection to the thermal break 406. Further, some of the mounting features 420 and 424 of the thermal break 406 may act as “stops” to facilitate proper positioning of the trim component 414 relative to the thermal break 406.

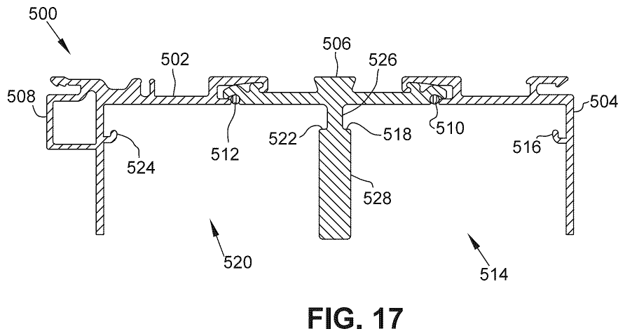

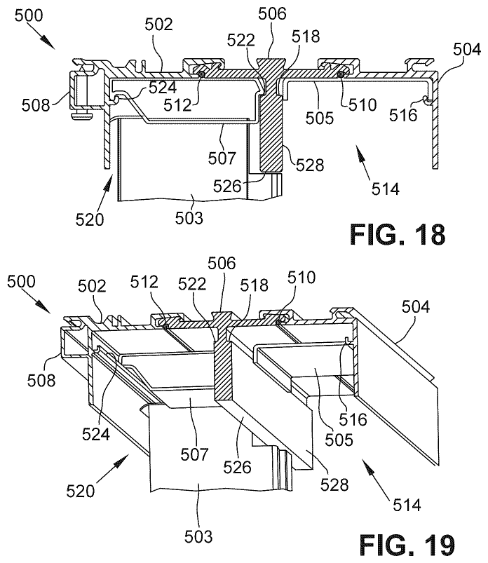

FIGS. 17-19 illustrate a portion of a frame 500 of a fenestration unit, according to an embodiment of the present disclosure, for installation in a building structure (not shown). More specifically, FIGS. 17-19 illustrate a portion of a header 502 of the frame 500. Although not specifically shown, a first jamb and a second jamb of the frame 500 may have substantially similar structures to the header 502. FIGS. 18 and 19 additionally illustrate a fixed panel 503 and auxiliary components, specifically a reinforcement bracket 505 and a panel securing bracket 507, coupled to the frame 500.

The frame 500 generally includes the same or substantially similar components as the frame 16 of the fenestration unit 10 (shown elsewhere), particularly a plurality of frame members and one or more thermal breaks. More specifically, the frame 500 includes an interior frame member 504, a thermal break 506, an exterior frame member 508, a first spline 510 coupling the interior frame member 504 to the thermal break 506, and a second spline 512 coupling the thermal break 506 to the exterior frame member 508. The interface between the first spline 510, the thermal break 506, and the interior frame member 504 may be the same or similar to the interface between the corresponding components of the fenestration unit 10. Similarly, the interface between the second spline 512, the thermal break 506, and the exterior frame member 508 may be the same or similar to the interface between the corresponding components of the fenestration unit 10. The frame members 504 and 508 may be constructed of the first, relatively strong material, as described above, more specifically a metal, for example aluminum, and the thermal break 506 may be constructed of the second material having a lower thermal conductivity than the first material, as described above, more specifically a polymeric material, even more specifically a polymer or a polymer composite. For example, the second material may be a thermoplastic (such as PVC), an extruded thermoplastic, a thermoset polymer, a composite (such as fiberglass, pultruded fiberglass, glass-filled polyamides), or the like.

The interior frame member 504 and the thermal break 506 bound and together define a first channel 514, in which a sliding panel or a fixed panel (not shown) is partially disposed. The interior frame member 504 and the thermal break 506 include mounting features 516 and 518, more specifically a mounting protrusion 516 and a mounting ledge 518, disposed in the first channel 514. The mounting features 516 and 518 facilitate coupling the interior frame member 504 and the thermal break 506 to auxiliary components disposed in the first channel 514, such as the reinforcement bracket 505 (FIGS. 18 and 19) and/or the internal corner brackets 86 and 94 (shown elsewhere).

The thermal break 506 and the exterior frame member 508 bound and together define a second channel 520, in which the fixed panel 503 (FIGS. 18 and 19) or a sliding panel (not shown) is partially disposed. The thermal break 506 and the exterior frame member 508 include mounting features 522 and 524, more specifically a mounting ledge 522 and a mounting protrusion 524, respectively, disposed in the second channel 520. The mounting features 522 and 524 facilitate coupling the thermal break 506 and the exterior frame member 508 to auxiliary components disposed in the second channel 520, such as the panel securing bracket 507 (FIGS. 18 and 19) and/or the internal corner brackets 86 and 94 (shown elsewhere).

The interior frame member 504 and the exterior frame member 508 may be the same or substantially similar to the interior frame member 72 and the exterior frame member 74, respectively (both shown elsewhere). The thermal break 506 may be the same or substantially similar to the thermal break 78 (shown elsewhere), except that the thermal break 506 lacks an outer channel for receiving features of mounting brackets, such as the outer channel 134 of the thermal break 78, and the neck 526 of the thermal break 506 includes a relatively wide base 528 that defines the mounting ledges 518 and 522.

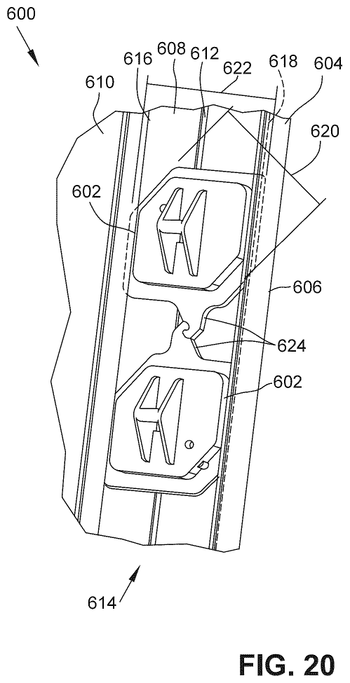

FIG. 20 illustrates a portion of a frame 600 and auxiliary components 602 of a fenestration unit, according to an embodiment of the present disclosure, for installation in a building structure (not shown). More specifically, FIG. 20 illustrates a portion of a jamb 604 of the frame 600. The frame 600 generally includes the same or substantially similar components as the frame 500 (shown elsewhere), particularly a plurality of frame members and one or more thermal breaks. More specifically, the frame 600 includes an interior frame member 606, a thermal break 608, an exterior frame member (obscured by a jamb cover 610), a first spline 612 coupling the interior frame member 606 to the thermal break 608, and a second spline (obscured by the jamb cover 610) coupling the thermal break 608 to the exterior frame member. The interface between the first spline 612, the thermal break 608, and the interior frame member 606 may be the same or similar to the interface between the corresponding components of the fenestration unit 10. Similarly, the interface between the second spline, the thermal break 608, and the exterior frame member may be the same or similar to the interface between the corresponding components of the fenestration unit 10.

The interior frame member 606, the exterior frame member, and the thermal break 608 may be the same or substantially similar to the interior frame member 504, the exterior frame member 508, and the thermal break 506, respectively (both shown elsewhere). More specifically, the interior frame member 606 and the thermal break 608 bound and together define a first channel 614, into which a sliding panel (not shown) is movable. The interior frame member 606 and the thermal break 608 include mounting features 616 and 618, more specifically a mounting protrusion 616 and a mounting ledge 618, disposed in the first channel 614. The mounting features 616 and 618 facilitate coupling the interior frame member 606 and the thermal break 608 to the auxiliary components 602 disposed in the first channel 614, such as locking brackets 602 selectively engaged by locking components of the sliding panel. Illustratively, the auxiliary components 602 are structured to facilitate easily coupling the components 602 to the frame 600. More specifically, the auxiliary components 602 include a first width 620 that is less than the smallest width of the first channel 614, near the outside of the channel 614 and apart from the mounting features 616 and 618. As such, the auxiliary components 602 may be inserted in the channel 614 when the components are oriented such that the first width 620 is substantially perpendicular to the channel 614. The auxiliary components 602 also include a second width 622 that is greater than the smallest width of the first channel 614. As such, after being inserted in the channel 614, the auxiliary components 602 may be pivoted to engage the mounting features 616 and 618 and are thereby retained in the channel 614. Additionally, pivoting the auxiliary components 602 may couple the components 602 via couplings 624.

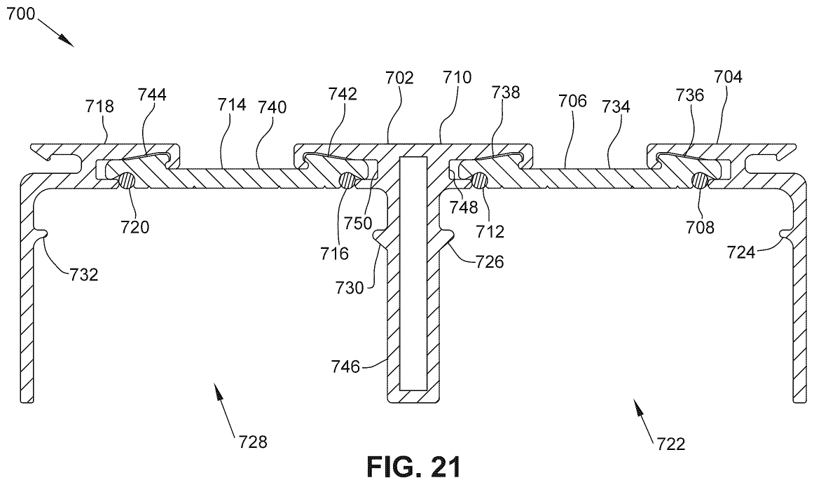

FIG. 21 illustrates a portion of a frame 700 of a fenestration unit, according to an embodiment of the present disclosure. More specifically, FIG. 21 illustrates a portion of a header 702 of the frame 700. Although not specifically shown, a first jamb and a second jamb of the frame 700 may have substantially similar structures to the header 702. The frame 700 generally includes substantially similar components as the frame 16 of the fenestration unit 10 (shown elsewhere), particularly a plurality of frame members and one or more thermal breaks. More specifically, the frame 700 includes an interior frame member 704, a first thermal break 706, a first spline 708 coupling the interior frame member 704 to the first thermal break 706, an intermediate frame member 710, a second spline 712 coupling the first thermal break 706 to the intermediate frame member 710, a second thermal break 714, a third spline 716 coupling the intermediate frame member 710 to the second thermal break 714, an exterior frame member 718, and a fourth spline 720 coupling the second thermal break 714 to the exterior frame member 718. The interfaces between the first spline 708 and adjacent components, the second spline 712 and adjacent components, the third spline 716 and adjacent components, and/or the fourth spline 720 and adjacent components may be the same or similar to the interface between the corresponding components of the fenestration unit 10. The frame members 704, 710, and 718 may be constructed of the first, relatively strong material, as described above, more specifically a metal, for example aluminum, and the thermal breaks 706 and 714 may be constructed of the second material having a lower thermal conductivity than the first material, as described above, more specifically a polymeric material, even more specifically a polymer or a polymer composite. For example, the second material may be a thermoplastic, (such as PVC), an extruded thermoplastic, a thermoset polymer, a composite (such as fiberglass, pultruded fiberglass, glass-filled polyamides), or the like.

The interior frame member 704, the first thermal break 706, and the intermediate frame member 710 bound and together define a first channel 722, in which a sliding panel or a fixed panel (not shown) is partially disposed. The interior frame member 704 and the intermediate frame member 710 include mounting features 724 and 726, more specifically mounting protrusions 724 and 726, disposed in the first channel 722. The mounting features 724 and 726 facilitate coupling the interior frame member 704 and the intermediate frame member 710 to auxiliary components disposed in the first channel 722, such as the internal corner brackets 86 and 94 (shown elsewhere).

The intermediate frame member 710, the second thermal break 714, and the exterior frame member 718 bound and together define a second channel 728, in which a sliding panel or a fixed panel (not shown) is partially disposed. The intermediate frame member 710 and the exterior frame member 718 include mounting features 730 and 732, more specifically protrusions 730 and 732, respectively, disposed in the second channel 728. The mounting features 730 and 732 facilitate coupling the intermediate frame member 710 and the exterior frame member 718 to auxiliary components disposed in the second channel 728, such as the internal corner brackets 86 and 94 (shown elsewhere).

The interior frame member 704 and the exterior frame member 718 may be the same or substantially similar to the interior frame member 72 and the exterior frame member 74, respectively (both shown elsewhere). The first thermal break 706 and the second thermal break 714 may each include some of the features of the thermal break 78 (shown elsewhere). More specifically, the first thermal break 706 includes a single leg 734 having a first foot 736 and an opposite second foot 738, which may be the same or substantially similar to the first foot 100 and the second foot 110, respectively, of the thermal break 78. Similarly, the second thermal break 714 includes a single leg 740 having a first foot 742 and an opposite second foot 744, which may be the same or substantially similar to the first foot 100 and the second foot 110, respectively, of the thermal break 78. The intermediate frame member 710 also includes some features of the thermal break 78. More specifically, the intermediate frame member 710 includes a central neck 746, which may have the same or a substantially similar shape to the central neck 116 of the thermal break 78. The intermediate frame member 710 also includes a first foot-receiving channel 748 that receives the second foot 738 of the first thermal break 706 and the second spline 712, and a second foot-receiving channel 750 that receives the first foot 742 of the second thermal break 714 and the third spline 716.

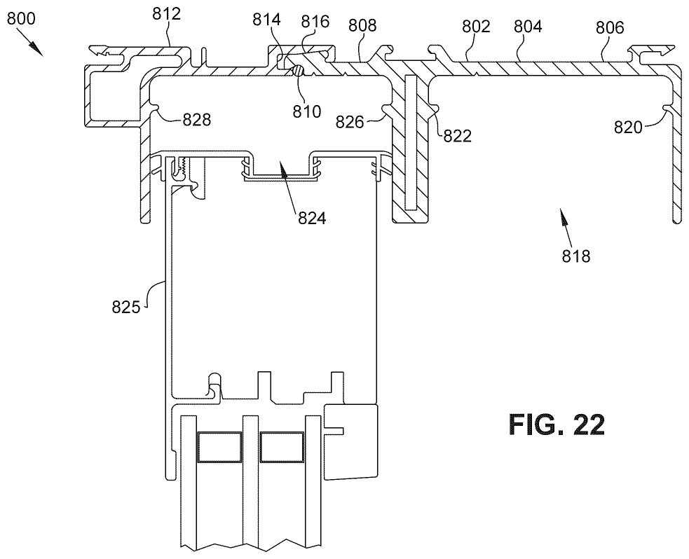

In certain embodiments, fenestration units according to the present disclosure may include one or more thermal breaks that are monolithically formed with, or integrally coupled to, one or more frame members. As an example, FIG. 22 illustrates a portion of a frame 800 of a fenestration unit, according to an embodiment of the present disclosure. More specifically, FIG. 22 illustrates a portion of a header 802 of the frame 800. Although not specifically shown, a first jamb and a second jamb of the frame 800 may have substantially similar structures to the header 802. The frame 800 includes an interior member 804, more specifically an interior frame member 806 that is monolithically formed with a thermal break 808. The frame 800 further includes a spline 810 coupling the thermal break 808 to an exterior frame member 812. The interface between the spline 810, the thermal break 808, and the exterior frame member 812 may be the same or similar to the interface between the corresponding components of the fenestration unit 10. More specifically, the exterior frame member 812 includes a foot receiving channel 814 that receives a foot 816 of the thermal break 808 and the spline 810.

The exterior frame member 812 may be constructed of the first, relatively strong material, as described above, more specifically a metal, for example aluminum, and the interior member 804 (that is, the monolithically formed thermal break 808 and interior frame member 806) may be constructed of the second material having a lower thermal conductivity than the first material, as described above, more specifically a polymeric material, even more specifically a polymer or a polymer composite. For example, the second material may be a thermoplastic (such as PVC), an extruded thermoplastic, a thermoset polymer, a composite (such as fiberglass, pultruded fiberglass, glass-filled polyamides), or the like.

The interior member 804 defines a first channel 818, in which a sliding panel or a fixed panel (not shown) is partially disposed. The interior member 804 includes mounting features 820 and 822, more specifically mounting protrusions 820 and 822, disposed in the first channel 818. The mounting features 820 and 822 facilitate coupling the interior member 804 to auxiliary components disposed in the first channel 818, such as the internal corner brackets 86 and 94 (shown elsewhere).

The thermal break 808 and the exterior frame member 812 bound and together define a second channel 824, in which a sliding panel or a fixed panel 825 is partially disposed. The thermal break 808 and the exterior frame member 812 include mounting features 826 and 828, more specifically protrusions 826 and 828, respectively, disposed in the second channel 824. The mounting features 826 and 828 facilitate coupling the thermal break 808 and the exterior frame member 812 to auxiliary components disposed in the second channel 824, such as the internal corner brackets 86 and 94 (shown elsewhere).

In other embodiments, the thermal break 808 may couple to the interior frame member 806 and the exterior frame member 812 in the opposite manner. That is, the exterior frame member 812 may be monolithically formed with the thermal break 808, and the interior frame member 806 may include a foot-receiving channel 814 that receives the foot 816 and the spline 810.

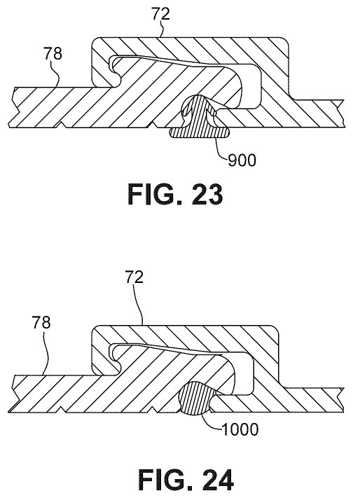

In certain embodiments, splines of fenestration units according to the present disclosure may have a different shape and/or be constructed of different materials than those described hereinabove. For example, FIG. 23 illustrates a dart-shaped spline 900 coupling the interior frame member 72 to the thermal break 78. Such a spline 900 may enhance sealing and aesthetics. As another example, FIG. 24 illustrates a spline 1000 constructed from a semi-rigid sealant or adhesive, more specifically a hot-melt adhesive, and coupling the interior frame member 72 to the thermal break 78. In certain embodiments, such a spline 100 does not adhesively bond the adjacent components (for example, the interior frame member 72 and the thermal break 78) together. Such a spline 1000 may enhance sealing and aesthetics.

### Assembly Methods for Fenestration Units

A method of assembling a fenestration unit including the header 502 of the frame 500 described in the foregoing sections is as follows. Methods of assembling other fenestration units contemplated herein may be substantially similar to the following method.

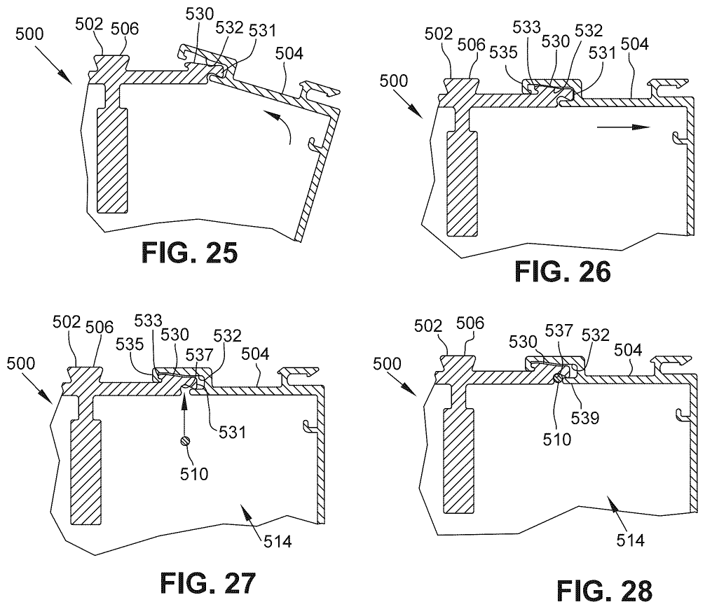

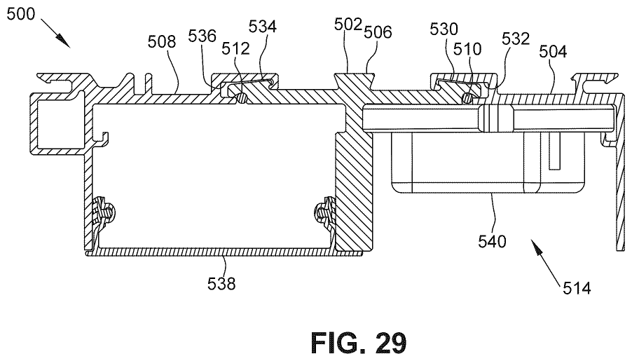

As illustrated in FIG. 25, the first foot 530 of the thermal break 506 is partially positioned in the first foot-receiving channel 532 of the interior frame member 504. More specifically, the thermal break 506 and the interior frame member 504 are positioned such that the toe portion 531 of the first foot 530 contacts the interior frame member 504 within the first foot-receiving channel 532. The interior frame member 504 is the pivoted relative to the thermal break 506, more specifically, the interior frame member 504 is cammed over the toe portion 531 of the first foot 530. As illustrated in FIG. 26, the relative motion of the interior frame member 504 and the thermal break 506 causes the first foot 530 of the thermal break 506 to be further, or fully, positioned in the first foot-receiving channel 532. In some cases and as illustrated, the heel portion 533 of the first foot 530 may be disposed apart from the hooked outer wall 535 of the interior frame member 504. In such cases, the interior frame member 504 is then translated relative to the thermal break 506 such that, as illustrated in FIG. 27, the heel portion 533 of the first foot 530 contacts the hooked outer wall 535 of the interior frame member 504. As illustrated in FIG. 27, the first spline 510 is then moved toward the first channel 514. As illustrated in FIG. 28, the spline 510 is then positioned between the first foot 530 and the interior frame member 504, more specifically in the concave recess 537 of the first foot 530 and in contact with the inner wall 539 of the interior frame member 504 and the first foot 530. This action secures the thermal break 506 to the interior frame member 504 and provides structural stability to the frame 500. In some embodiments, positioning the spline 510 between the first foot 530 and the interior frame member 504 non-reversibly or non-detachably secures the thermal break 506 to the interior frame member 504. In other embodiments, positioning the spline 510 between the first foot 530 and the interior frame member 504 reversibly or detachably secures the thermal break 506 to the interior frame member 504. In some embodiments and as illustrated in FIG. 29, the method further includes coupling the thermal break 506 to the exterior frame member 508, more specifically, via the second foot 534, the second foot-receiving channel 536, and the second spline 512 and in a similar manner as coupling the thermal break 506 to the interior frame member 504. In some embodiments and as illustrated in FIG. 29, the method further includes coupling one or more auxiliary components, such as a jamb cover 538 and a panel locking device 540, to the frame 500 to further secure the interior frame member 504 and the exterior frame member 508 to the thermal break 506 and thereby provide further structural stability to the frame 500. In some embodiments, the jambs of the frame 500 may be assembled in a similar manner as the header 502. In some embodiments, the auxiliary components may be internal corner brackets 86 and 94 (shown elsewhere) that couple the header 502 to one or more of the jambs of the frame 500.

Fenestration units according to embodiments of the present disclosure may be modified in various other manners. For example, in some embodiments one or more frame members include one or more feet, and one or more thermal breaks include foot-receiving channels for receiving such feet. As another example, in some embodiments one or more feet of the thermal breaks and/or the frame members have different shapes than those described hereinabove.

Although examples have been discussed relating to fenestration units with both sliding panels and fixed panels, it is understood that the concepts and features discussed herein may be implemented in a variety of fenestration systems, including fixed panel units, hinged units, and so forth.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

What is claimed is:

1. A fenestration unit, comprising:
a frame, comprising:
an interior frame member;
an exterior frame member adjacent the interior frame member, wherein at least one of the interior frame member and the exterior frame member comprise a foot-receiving channel;
a thermal break coupling the interior frame member to the exterior frame member, the thermal break comprising a foot positioned in the foot-receiving channel; and
a spline received by the foot of the thermal break and securing the thermal break to the at least one of the interior frame member and the exterior frame member.

2. The fenestration unit of claim 1, wherein the foot-receiving channel is a first foot-receiving channel, the foot is a first foot, the other of the interior frame member and the exterior frame member comprises a second foot-receiving channel, and the thermal break comprises a second foot positioned in the second foot-receiving channel.

3. The fenestration unit of claim 1, wherein the spline non-detachably secures the thermal break to the at least one of the interior frame member and the exterior frame member.

4. The fenestration unit of claim 2, wherein the spline is a first spline, and further comprising a second spline received by the second foot of the thermal break and securing the thermal break to the other of the interior frame member and the exterior frame member.

5. The fenestration unit of claim 2, wherein the thermal break further includes a neck between the first foot and the second foot.

6. The fenestration unit of claim 5, wherein the neck of the thermal break comprises and interior chamber.

7. The fenestration unit of claim 1, wherein the thermal break is a first thermal break, and further comprising:
an intermediate frame member coupled to the first thermal break opposite the interior frame member; and
a second thermal break coupled to the intermediate frame member opposite the first thermal break, and the second thermal break coupled to the exterior frame member opposite the intermediate frame member.

8. The fenestration unit of claim 1, further comprising a compressible pad coupled to the thermal break and configured to be compressed upon thermal expansion of the thermal break.

9. The fenestration unit of claim 1, further comprising a sliding panel coupled to the frame.

10. The fenestration unit of claim 9, further comprising a fixed panel coupled to the frame.

11. The fenestration unit of claim 1, wherein the spline acts as a seal between the thermal break and the at least one of the interior frame member and the exterior frame member.

12. The fenestration unit of claim 1, wherein the spline comprises an adhesive.

13. A method of assembling a fenestration unit, comprising:
providing an interior frame member, an exterior frame member, and a thermal break, at least one of the interior frame member and the exterior frame member comprising a foot-receiving channel, and the thermal break comprising a foot;
positioning the foot in the foot-receiving channel;
positioning a spline between the foot and the at least one of the interior frame member and the exterior frame member; and
coupling the thermal break to the other of the interior frame member and the exterior frame member.

14. The method of claim 13, wherein positioning the foot in the foot-receiving channel comprises pivoting the at least one of the interior frame member and the exterior frame member relative to the thermal break.

15. The method of claim 13, wherein the foot-receiving channel is a first foot-receiving channel, the foot is a first foot, the spline is a first spline, the other of the interior frame member and the exterior frame member comprises a second foot-receiving channel, the thermal break comprises a second foot, and coupling the thermal break to the other of the interior frame member and the exterior frame member comprises:
positioning the second foot in the second foot-receiving channel; and
positioning a second spline between the second foot and the other of the interior frame member and the exterior frame member.

16. The method of claim 13, wherein the thermal break is a first thermal break, and further comprising:
providing an intermediate frame member and a second thermal break; and
coupling the second thermal break between the intermediate frame member and the exterior frame member.

17. The method of claim 13, further comprising coupling a compressible pad to the thermal break.

18. The method of claim 13, further comprising coupling an auxiliary component between the thermal break and the at least one of the interior frame member and the exterior frame member.

19. The method of claim 18, wherein the auxiliary component comprises an internal corner bracket.

20. The method of claim 13, wherein positioning the spline between the foot and the at least one of the interior frame member and the exterior frame member non-detachably secures the thermal break to the at least one of the interior frame member and the exterior frame member.

21. A fenestration unit, comprising:
a frame, comprising:
an interior frame member;
an exterior frame member adjacent the interior frame member;
a polymeric thermal break coupling the interior frame member to the exterior frame member; and
a compressible pad configured to be compressed upon thermal expansion of the polymeric thermal break.

22. The fenestration unit of claim 21, wherein the compressible pad is disposed between the thermal break and a corner bracket of the frame.
